(19) United States
(12) Patent Application Publication
(10) Pub. No.: US 2021/0016229 A1
(43) Pub. Date: Jan. 21, 2021

(54) Transport Unit for a Filter Module, and Method for Transporting a Filter Module

(71) Applicant: Nanostone Water GmbH, Halberstadt (DE)

(72) Inventors: Michael Leistner, Halberstadt (DE); Bernd Koecher, Wegeleben (DE); Daniel Ahlers, Quedlinburg (DE)

(21) Appl. No.: 16/770,913

(22) PCT Filed: Dec. 3, 2018
(86) PCT No.: PCT/EP2018/083290

§ 371 Date: Oct. 6, 2020

(30) Foreign Application Priority Data
Dec. 28, 2017 (DE) 10 2017 131 375.3

(51) Int. Cl. B01D 65/00; B01D 63/06; B65D 81/05; B65D 85/64

(52) U.S. Cl. CPC B01D 65/006; B65D 85/64; B65D 81/053; B01D 63/066

(57) ABSTRACT

The invention relates to a method for transporting a filter module (10) comprising an elongate and tubular housing (12) and at least one flat filter segment (26) arranged in the housing (12), said method comprising the following steps: a. arranging the filter module (10) in a transport container (44); and b. orienting the filter module (10) in the transport container (44) such that a plane of the filter segment (26) is arranged at least approximately vertically in the normal transport position of the transport container (44).

The invention relates to a transport unit for a filter module, according to the preamble of claim 1, and to a method for transporting a filter module, according to the preamble of the coordinated claim.

DE 10 2016 107 534 A1 discloses a filter module for filtering a liquid. Such a filter module comprises a tubular housing. The tubular housing is elongated and, all in all, approximately straight, so that it has a longitudinal axis. A first axis of a Cartesian system of coordinates is defined hereby. In the tubular housing is arranged a monolith, which has a plurality of filter membranes configured as so-called “flat membranes”. Flat membranes are filter membranes which have a comparatively flat cross section, the width of which thus normally amounts to a multiple of its height.

The filter membranes are made of a ceramic material and are passed through in their longitudinal direction by filtration channels, which on their inner side are coated with a filtration membrane likewise made of a ceramic material. The filter segments are provided at their axial ends with a connecting body which is made of a casting material and by which they are held relative to one another within the housing. Further belonging to the housing is a connecting socket, which can be used as an outlet for a purified liquid (filtrate) and can be used as an inlet for a liquid when the filter module is due to be cleaned, thus freed from the retentate.

The object of the present invention is to provide a transport unit which ensures a secure transport of the filter module from one location to another location, so that the filter module is not damaged by the transport and the filter performance after the transport is the same as before the transport.

This object is achieved by a transport unit having the features of claim 1. Exemplary refinements of the invention are cited in subclaims. In addition, features which are fundamental to the invention are found in the following description and in the accompanying drawing. These features can here be fundamental to the invention both in isolation and in different combinations, without reference being once again explicitly made hereto.

The transport unit according to the invention comprises a filter module for filtering a liquid. This filter module, in turn, comprises an elongate tubular housing, which, in this respect, has a longitudinal axis defining a first axis of a Cartesian system of coordinates. Further belonging to the filter module is a monolith, which is arranged in the housing and comprises at least one elongate and flat filter segment. “Flat” here means that the cross section of the filter segment is significantly wider than it is high. Preferably, the width amounts to a multiple of the height.

The cross-sectional shape of the filter segment can be rectangular, but it can also be trapezoidal or have a different polygonal cross section. “Elongate” means that the filter segment extends in a direction orthogonal to its cross-sectional plane, which extent defines a longitudinal axis. This longitudinal axis runs at least approximately parallel to the longitudinal axis of the housing.

The filter segment is preferably made of an open-pored ceramic material and is passed through in its longitudinal direction, from one end to the other, by a plurality of filtration channels. These filtration channels are preferably coated on their inner side with a ceramic filtration layer. Alternatively hereto, the filter segment can also be coated on its outer side with such a filtration layer.

The filter module has a marking which is visually perceptible from outside and defines a second axis of the Cartesian system of coordinates, running radially relative to the housing. This marking can in principle be arranged at any place on the outer side of the filter module, thus also on one of the end faces. The first and the second axis span a reference plane. The monolith is arranged in such a way relative to the housing that the at least one (flat) filter segment is arranged at least approximately parallel to the reference plane. It is here self-evident that the term “approximately parallel” should not be construed restrictively. In practice, orientations up to an angle of approximately +/−45° in relation to the reference plane should also be covered hereby.

Further belonging to the transport unit is a transport container, in which the filter module is arranged. Such a transport container serves, for instance, to transport the ready-mounted filter module from a production site to a usage site. The filter module is thus arranged in said transport container only during the transport. The transport is realized, for instance, by a land vehicle, an aircraft and/or a watercraft. According to the invention, it is proposed that the transport container has a top side, and that the filter module is arranged in the transport container such that the second axis points at least approximately upward.

The fact that the second axis points at least approximately upward ensures that the filter module, during the transport, is oriented such that the plane of the filter segment is oriented approximately vertically, wherein “vertically” here too includes, in turn, an orientation in an angular range of approximately +/−45° relative to the vertical. However, smaller angular ranges, for instance, +/−30°, or +/−15°, or +/−10°, or +/−5°, are more strongly preferred.

The vertical arrangement of the plane of the filter segment is advantageous by virtue of the fact that, in transports, the main thrust, i.e. that direction in which particularly strong abrupt accelerations can arise during a transport, is an approximately vertical direction. A vertical shock occurs, for instance, when the transport container falls from a certain height onto a base surface. However, the filter segment has the highest rigidity about an axis which is orthogonal to the large side faces of the flat filter segment. The filter segment is thus preferably arranged “on edge”, which means that its plane is arranged at least approximately vertically. In this way, the above-described shocks can be absorbed particularly well by the filter segment.

With the transport unit according to the invention, it is therefore ensured that the filter module can also withstand strong vertical shocks with as little damage as possible, i.e., for instance, in a filter module made of a ceramic material no cracks are formed. No additional costly or heavyweight devices whatsoever are here necessary, but rather this effect is produced solely by the filter module being arranged purposefully and deliberately within the transport packaging such that the flat filter segment present in the filter module is arranged within the transport packaging in a desired manner, namely in an at least substantially vertical plane or on edge.

In a first refinement, it is proposed that the marking is arranged on a radial outer side of the tubular housing. Such a marking is particularly easy to detect.

It is further proposed that the marking comprises an at least substantially radially extending connecting socket or is formed thereby, and/or comprises a fastening device or is formed thereby, and/or comprises a sticker or is formed thereby. In the case of a connecting socket or a fastening device (for instance, for raising, mounting, etc. of the filter module), no separate marking at all is necessary, but rather a pre-existing portion or a pre-existing element is used as the marking. A connecting socket additionally offers the advantage that a view through into the inside of the filter module is granted, thereby allowing checking of the actual orientation of the filter segment present inside. By contrast, a sticker has the advantage that the filter segment can be introduced into the housing and arranged therein in any chosen manner, and that the marking can subsequently be applied regardless of the actual orientation.

It is particularly advantageous if the monolith comprises a plurality of flat filter segments, which are arranged parallel to one another and parallel to the reference plane. In this way, between the individual filter segments are formed flat, i.e. relatively narrow, interspaces. Such a filter module is particularly efficient, since a large filtration area is provided.

It is also proposed that the housing has two opposite axial end portions of larger diameter, and a middle portion, disposed between the end portions, of smaller diameter. This reduces the dead volume and facilitates the integration of the filter segment or filter segments into the housing.

It is here in turn preferred that the connecting socket is arranged in one of the axial end portions. This has system-related advantages in connection with the integration of the filter module into a filter system.

A further refinement is distinguished by the fact that the monolith, in the region of the respective axial ends of the filter segment or plurality of filter segments, has respectively a connecting body, which secures the position of the filter segments relative to one another. The connecting body can be produced, for instance, by casting of an initially liquid and then hardening casting material. In this way, a reliable fixing of the filter segments relative to one another is created.

The advantages according to the invention are additionally reinforced if the filter module is supported in the transport container by means of a shock-absorbing device comprising at least two portions made of a laminated cardboard material, which are arranged transversely to the longitudinal axis of the filter module and which support the filter module, in relation to the transport container, at at least two axially spaced points.

Another preferred embodiment of the transport unit according to the invention is distinguished by virtue of the fact that it has a device which allows the filter module to be mounted in the transport container only in a predefined orientation. In this way, the filter module is prevented from being arranged in the transport container in other than the desired manner, thereby ensuring that the filter module is mounted in the transport container in such an orientation that the filter segments can optimally absorb shocks which arise during the transport.

Also belonging to the invention is a method for transporting a filter module, comprising an elongate and tubular housing and at least one flat filter segment arranged in the housing, wherein the method comprises the following steps:
a. arrangement of the filter module in a transport container; and
b. orientation of the filter module in the transport container such that a plane of the filter segment, in the normal transport position of the transport container, is arranged at least approximately vertically.

Below, an embodiment of the invention is explained by way of example with reference to the accompanying drawing, in which:

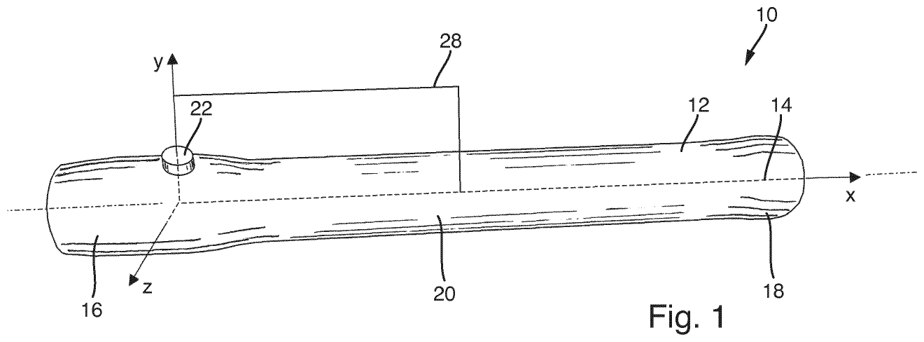

FIG. 1 shows a perspective representation of a filter module;

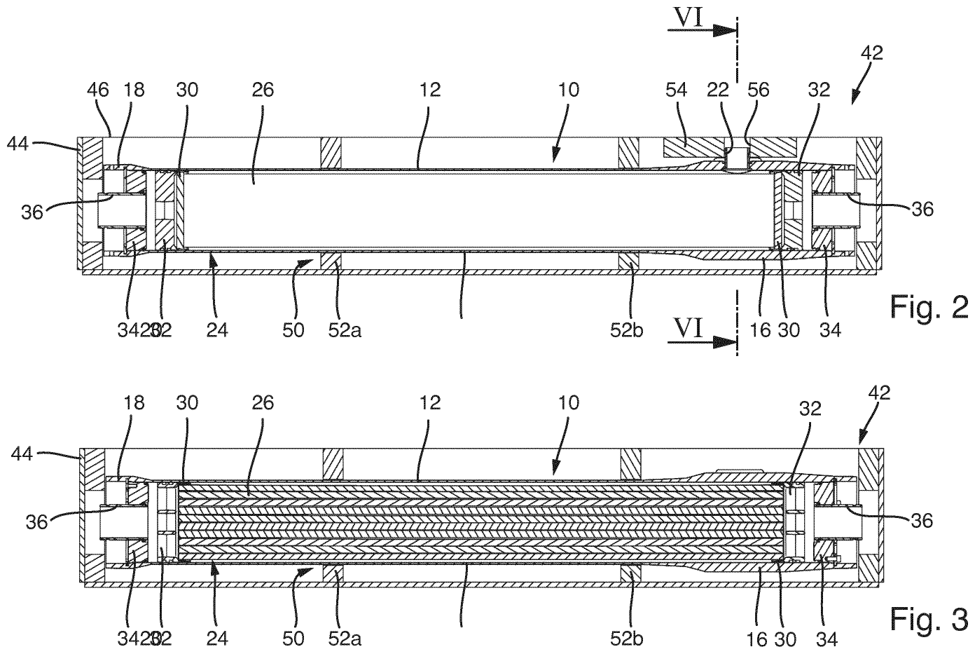

FIG. 2 shows a section through a transport unit containing the filter module from FIG. 1, in a vertical sectional plane;

FIG. 3 shows a section through the transport unit of FIG. 2, in a horizontal sectional plane;

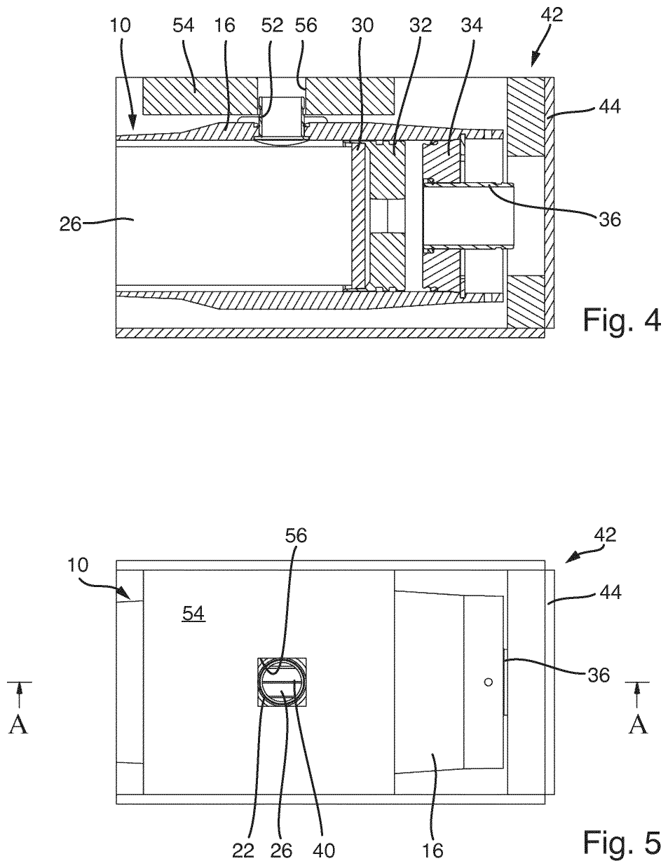

FIG. 4 shows an enlarged region from FIG. 2;

FIG. 5 shows the region from FIG. 4 in top view;

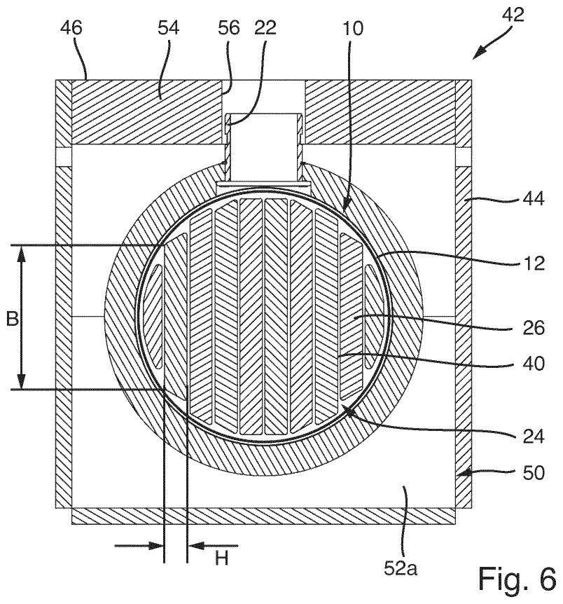

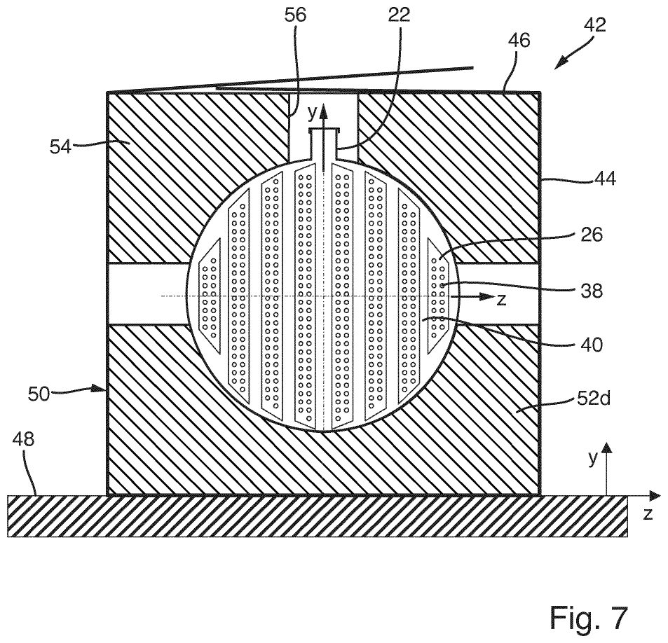

FIG. 6 shows a section along the line VI-VI from FIG. 2; and

FIG. 7 shows a schematic section similar to FIG. 6.

In the figures, a filter module, in its entirety, bears the reference symbol 10. During operation, it serves for the filtering of a liquid, for instance for the filtering of water. The filter module 10 comprises a tubular housing 12, which has a longitudinal axis 14 that defines a first axis, namely in the present case an x-axis, of a Cartesian system of coordinates.

The housing 12 has two opposite axial end portions 16 and 18, between which is disposed a middle portion 20. As can be seen from the figures, the two axial end portions 16 and 18 have in comparison to the middle portion 20 a larger external diameter. By contrast, the internal diameter of the tubular housings 12 is constant over the length of the tubular housing 12. As can be seen, in particular, also from FIG. 1, the housing 12 has a connecting socket 22, which extends substantially radially and has a circular-cylindrical cross section.

This connecting socket 22 too has a longitudinal axis, which is not, however, represented in the figure. By this, a second axis of the abovementioned Cartesian system of coordinates is defined, which axis runs radially relative to the longitudinal axis of the housing 12, namely in the present case the y-axis. In the represented position of the filter module 10, the y-axis extends vertically upward. Accordingly, a third axis of the Cartesian system of coordinates, namely the z-axis, runs horizontally sideways.

In the housing 12 is arranged a so-called “monolith”. This, in its entirety, bears the reference symbol 24. It comprises a plurality of elongate and flat filter segments 26, which in the present embodiment are made, by way of example, of an open-pored ceramic material and of which in the figures, however, for reasons of clarity, respectively only one is provided with a reference symbol.

“Flat” means in the present case that the cross section of the filter segments 26 is such that a width B of a filter segment 26 is significantly larger than a height H of the filter segment 26 (see FIG. 6), preferably such that the width B of a filter segment 26 amounts to a multiple of the height H of the filter segment 26, as can be seen, for instance, from FIGS. 6 and 7. “Elongate” means that the length of a filter segment 26 is significantly larger than the width B. A longitudinal axis of the filter segments 26 runs in the present case parallel to the longitudinal axis of the housing 12, and thus parallel to the x-axis.

As can be seen from FIG. 1, the x-axis and the y-axis span a reference plane 28, which, in that position of the filter module 10 that is represented in FIG. 1, is vertically oriented. As is evident, for instance, from FIGS. 6 and 7, the monolith 24 is arranged relative to the housing 12 such that the filter segments 26 are arranged approximately parallel to the reference plane 28. In other words: the widthwise extent B of the filter segments 26 runs approximately parallel to the y-axis of the housing 12.

Belonging to the monolith 24 are also two connecting bodies 30 (see, for instance, FIGS. 2 and 4), of which one is arranged in the region of the axial end portion 16 and the other in the region of the axial end portion 18. The connecting body 30 is made of a plastics casting material, which is initially liquid and then hardened. By the connecting body 30, the filter segments 26 are secured in position relative to one another. The respective axial end portions 16 and 18 are accommodated, with the connecting bodies 30 which are present there, in respective retaining rings 32, which, in turn, cooperate in a fluid-tight manner with the inner side (without reference symbol) of the housing 12.

At an axial distance from the respective retaining rings is respectively held in a fluid-tight manner in the housing 12 an end plate 34, which respectively has a connecting socket 36. During operation of the filter module 10, a supply for a liquid to be filtered can be connected to the one connecting socket 36, whereas the other connecting socket 36 is either closed off or serves for the return of the liquid to be filtered.

As is merely indicated in the schematic representation of FIG. 7, the filter segments 26 are respectively passed through, from one axial end face (without reference symbol) up to the other axial end face (without reference symbol), by a multiplicity of filtration channels 38, of which in FIG. 7, for reasons of clarity, only one is provided with a reference symbol. In the present embodiment, the walls of the filtration channels 38 are provided with a thin ceramic filtration membrane (not illustrated).

During operation of the filter module 10, liquid to be filtered is forced through the filtration channels 38 and the retentate is retained by the filtration membranes. The filtrate, by contrast, penetrates the filtration membranes and the open-pored ceramic of the respective filter segment 26 and, in this way, makes its way primarily into flat interspaces 40 formed between the filter segments 26, and from there to the connecting socket 22. Alternatively, an outer side of the filter segments 26 could also be coated with a filtration membrane, whereby the retentate would accumulate on the outer side of the filter segments 26.

Accordingly, the liquid to be filtered would be fed through the connecting socket 22 and the filtrate led off through the connecting socket 36.

After the production of the filter module 10, there is a need to be able to transport the filter module 10 from one location to another without the filter module 10 being damaged by the transport, for instance in that, through shocks arising during the transport, cracks come to be formed in the open-pored ceramic and/or in the filter membranes of a filter segment 26 or of a plurality of filter segments 26 of the filter module 10. For instance, there is a need to transport the filter module 10 from the production site to that site at which the filter module 10 is operated. This can comprise a transport by means of a land vehicle, a watercraft and/or an aircraft, and such a transport normally incorporates some transfer operations, for instance, by means of a forklift truck or by means of a crane.

In order to protect the filter module 10 from damage during such a transport, the filter module 10, during such a transport, forms a part of a transport unit 42, as is represented in FIGS. 2-7. This transport unit 42 comprises, in addition to the filter module 10, a transport container 44, in which the filter module 10 is accommodated and arranged. The transport container 44 can be constituted, for instance, by a cardboard box, or by a container made of a plastic or of a metal material.

As can be seen, in particular, from FIGS. 6 and 7, the transport container 44 has a substantially rectangular cross section, and the transport container 44 has a top side 46, i.e. a side of the kind which points or is intended to point upward during the transport of the transport unit 42. This is ensured, for instance, by appropriate markings on the transport container 44, which markings indicate to an operator handling the transport container 44 during the transport that the transport container 44 must solely be oriented such that the top side 46 is also actually at the top.

As can likewise be seen, in particular, from FIGS. 6 and 7, the filter module 10 is arranged in the transport container 44 such that the second axis, i.e. the y-axis, points at least approximately upward. Since, as has been mentioned above, the filter segments 26 are arranged in the housing 12 such that they are disposed parallel to the reference plane 28 spanned by the y-axis and the y-axis, through the arrangement of the filter module 10 such that the y-axis points upward it is ensured that, during the transport of the transport unit 42, the filter segments 26 are arranged on edge, i.e. their planes running in the widthwise direction B are vertical.

This is based on the consideration that the flexural rigidity of the filter segments 26 about an axis running orthogonally to their planes, i.e. in the present case an axis oriented parallel to the z-axis, is at a maximum. It is further based on the consideration that, during a transport of the transport unit 42, the maximal shocks, i.e. the greatest accelerations, usually arise in the vertical direction, for instance when the transport container 44 is dropped onto a base surface (reference symbol 48 in FIG. 7), or when, for instance, a land vehicle which transports the transport container 44 drives over a chuckhole.

By virtue of the above-described orientation of the filter segments 26, abrupt loads of this kind can be optimally absorbed by the filter segments 26 without the maximally permitted stresses being exceeded in the filter segments 26. In this way, it is optimally avoided that, due to the aforementioned shock loads during the transport of the transport unit 42, cracks come to be formed, for instance, whereby the integrity of a filter segment 26, and hence of the entire filter module 10, would be damaged, and hence its efficiency impaired.

In order to be able to arrange the filter module 10 in the transport container 44 in the desired manner, an operator inserting the filter module 10 into the transport container 44 must be able to detect as quickly and clearly as possible an appropriate visually perceptible marking which indicates to him the filter module 10 must be arranged in the transport container 44. The tubular housing 12 is namely in virtually all cases opaque, so that an operator cannot readily detect from outside how the filter segments 26 are arranged inside the housing 12.

In the present case, this marking, which is visually perceptible from outside, is formed by the connecting socket 36. Upon the installation of the filter segments 26 into the housing 12, these are namely arranged such that their planes, running in the widthwise direction B, are oriented parallel to the reference plane 28, which, in turn, is spanned, inter alia, by the y-axis running through the connecting socket 22. If the filter module 10 is inserted into the transport container 44 such that the connecting socket 22 points at least approximately upward, it is in this way ensured that the filter segments 26 are in the desired substantially vertical orientation.

It is here self-evident that, in principle, also other types of visually perceptible markings are conceivable. For instance, on the outer side of the housing 12 could also be present a sticker which imparts to the operator the necessary information on the orientation of the filter module 10 within the transport container 44. The sticker can here be arranged on a radial outer side of the tubular housing 12, but it can also, for instance, be present on one of the end plates 34 or on both end plates 34.

Identical in effect and equivalent to a sticker would also be some other marking, for instance a direct imprint, a notch, or something similar. All this would have the advantage that the filter segments 26 could be arranged independently from the connecting socket 22. For instance, the filter segments 26 could be arranged in the housing 12 in any particular and arbitrary manner, and subsequently, by the application of the marking, i.e. of the sticker, for instance, the operator could be informed of the actual orientation of the filter segments 26 within the housing 12.

It is also possible for other devices which are anyway present in a filter module 10 to be used as a marking. For instance, the filter module 10 can have devices in order to be able to raise the filter module 10, for instance by means of a crane. Such a device can be, for instance, a lifting eye, or something similar. This too can serve as an appropriate marking.

Nor is it absolutely necessary that the marking is arranged precisely at the top or defines that top side of the filter module 10 that is desired during the transport of the filter module 10. It is also possible for the visual marking to be fitted on the side, with the proviso that the filter module 10 is inserted into the transport container 44 such that the marking is arranged on the side.

Furthermore, in the above-described embodiment, the filter segments 26 are arranged in the transport container 44 such that their planes running in the widthwise direction B are oriented during the transport, by and large, exactly vertically. However, the above-stated advantages according to the invention can also be obtained—even if in reduced measure—if the filter segments 26 are oriented not exactly vertically, but rather, for instance, are arranged at an angle of approximately 45° to the vertical. Greater preference is for an angle of 30°, of 15°, of 10°, and also of 5°.

The filter module 10 is supported in the transport container 44 by means of a shock-absorbing device 50. In the present case, this comprises two portions 52a and 52b, made of a laminated cardboard material, which are arranged transversely to the longitudinal axis (x-axis) of the filter module 10. In this way, the filter module 10 is supported in the transport container 44 at two axially spaced points.

As can be seen, for instance, from FIGS. 2, 4 and 6, the transport unit 42 further has an upper cover element 54, which is made, by way of example, likewise of a very thick multilayered capping material. The cover element 54 has such external dimensions that it fits exactly into the transport container 44. In addition, the cover element 54 possesses an opening 56, into which, once the cover element 54 is inserted into the transport container 44, the connecting socket 22 at least partially projects.

It is evident that the cover element 54 can only then be arranged correctly in the transport container 44 when the connecting socket 22 points vertically upward, i.e. the filter module 10 is oriented in the desired manner. The cover element 54 thus forms together with the opening 56 a device which allows the filter module 10 to be mounted in the transport container 44 only in a predefined orientation, namely with upward pointing connecting socket 22.

1.-10. (canceled)

11. A transport unit, comprising:
a filter module, comprising:
a tubular housing having a longitudinal axis defining a first axis; and
a marking which is visually perceptible from outside the filter module, the marking defining a second axis extending radially relative to the housing;
a monolith in the tubular housing, the monolith comprising an elongate, flat filter segment having a longitudinal axis at least approximately parallel to the longitudinal axis of the tubular housing; and
a transport container housing the filter module,
wherein:
the elongate, flat filter segment is at least approximately parallel to a reference plane defined by the first and second axes;
the transport container has a first side; and
the second axis points toward the first side.

12. The transport unit of claim 11, wherein the marking is on a radial outer side of the tubular housing.

13. The transport unit of claim 12, wherein the marking comprises at least one member selected from the group consisting of a connecting socket, a fastening device and a sticker.

14. The transport unit of claim 12, wherein the monolith comprises a plurality of flat filter segments arranged parallel to one another and parallel to the reference plane.

15. The transport unit of claim 11, wherein the monolith comprises a plurality of flat filter segments arranged parallel to one another and parallel to the reference plane

16. The transport unit of claim 11, wherein the housing comprises a middle portion between two axial end portions, and a diameter of the middle portion is smaller than a diameter of either of the axial end portions.

17. The transport unit of claim 16, wherein, in a region of axial ends of the elongate, flat filter segment, the monolith comprises a connecting body securing the filter segments relative to one another.

18. The transport unit of claim 16, wherein the marking is on a radial outer side of the tubular housing.

19. The transport unit of claim 16, wherein the monolith comprises a plurality of flat filter segments arranged parallel to one another and parallel to the reference plane.

20. The transport unit of claim 11, further comprising a device which comprises two portions, the two portions comprise laminated cardboard extending transverse to the longitudinal axis of the filter module, and the two portions support the filter module relative to the transport container at at least two axially spaced points.

21. The transport unit of claim 20, wherein the device comprises a shock-absorbing device.

22. The transport unit of claim 20, wherein the housing comprises a middle portion between two axial end portions, and a diameter of the middle portion is smaller than a diameter of either of the axial end portions.

23. The transport unit of claim 20, wherein the marking is on a radial outer side of the tubular housing.

24. The transport unit of claim 20, wherein the monolith comprises a plurality of flat filter segments arranged parallel to one another and parallel to the reference plane.

25. The transport unit of claim 11, further comprising a device configured to allow the filter module to be mounted in the transport container only in a predefined orientation.

26. The transport unit of claim 25, further comprising a second device, wherein the second device comprises two portions, the two portions comprise laminated cardboard extending transverse to the longitudinal axis of the filter module, and the two portions support the filter module relative to the transport container at at least two axially spaced points.

27. The transport unit of claim 25, wherein the housing comprises a middle portion between two axial end portions, and a diameter of the middle portion is smaller than a diameter of either of the axial end portions.

28. The transport unit of claim 25, wherein the marking is on a radial outer side of the tubular housing.

29. The transport unit of claim 25, wherein the monolith comprises a plurality of flat filter segments arranged parallel to one another and parallel to the reference plane.

30. A method of transporting a filter module comprising an elongate and tubular housing and a flat filter segment in the housing, the method comprising:
orienting of the filter module in a transport container so that, in a normal transport position of the transport container, a plane of the filter segment is at least approximately vertical.
